(19) United States
(12) Patent Application Publication
(10) Pub. No.: US 2017/0302863 A1
(43) Pub. Date: Oct. 19, 2017

(54) SPATIAL DETECTION DEVICES AND SYSTEMS

(71) Applicant: De la Cuadra, LLC, Cookeville, TN (US)

(72) Inventors: Vincente Ortiz, Cookeville, TN (US); Nicolas Paulat, Tours (FR)

(21) Appl. No.: 15/244,723

(22) Filed: Aug. 23, 2016

Related U.S. Application Data
(60) Provisional application No. 62/324,689, filed on Apr. 19, 2016.

(51) Int. Cl. H04N 5/33; A63F 13/213; G06T 7/20; H04N 5/225; A63F 13/211

(52) U.S. Cl. CPC H04N 5/33; H04N 5/2256; A63F 13/211; G06T 7/20; A63F 13/213; G06T 2207/30244

(57) ABSTRACT

Technologies are described herein for a spatial detection system for use in various applications. The spatial detection system comprises a handheld device and an IR apparatus. In some examples, the IR apparatus includes an infrared (“IR”) light emitting diode (“LED”) and the handheld device includes a camera. The handheld device can also include a gyroscope and an accelerometer. The handheld device sends information relating to the position in the matrix, the gyroscope, and the accelerometer to a receiver, which may be the same unit as the IR apparatus or may be another unit. The receiver receives the positional and movement information and can translate that movement as control inputs to software. In some examples, the software can be a game, physical treatment program, and the like.

### CROSS REFERENCE TO RELATED APPLICATIONS

This application claims the benefit of co-pending U.S. provisional application No. 62/324,689 filed Apr. 19, 2016, entitled “Game device,”, which is incorporated herein by reference in its entirety.

### COPYRIGHT

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

When using handheld devices, such as game devices or other control devices, the movement and location of the user's hand holding the device is an important feature. Spatial detection systems that determine a user's movement and translate the movement to an input often need to have a relatively high degree of accuracy. A device used in a spatial detection system would not be considered functional if movements of the user are not translated properly into an input. Devices are also considered non-functional when the spatial detection system receives inputs without any movement on the part of the human.

Further, accuracy to a desired degree can be important for spatial detection systems. If a spatial detection system only receives an input when relatively large movements of a user are detected, the user using the spatial detection system may not be able to move enough to provide desired inputs into the system. On the other hand, the user may be frustrated if the spatial detection system detects minute, undesired movements of the user and uses those movements as an input.

It is with respect to these and other considerations that the disclosure made herein is presented.

### SUMMARY

Technologies are described herein for a spatial detection system for use in various applications. In some examples, the spatial detection system comprises a handheld device and an IR apparatus. In some examples, the IR apparatus includes an infrared (“IR”) light emitting diode (“LED”) and the handheld device includes a camera. In some examples, the position of the handheld device is determined by first establishing a two dimensional, or planar, matrix. The plane of the matrix is typically parallel to the vector for gravitational acceleration, though the matrix can be adjusted for other purposes. The LED of the IR apparatus is energized, emitting IR light generally in the direction of the handheld device. The camera in the handheld device detects the IR light to determine a point in the matrix. The point in the matrix is determined by comparing an intensity or brightness of the IR light received by the pixels in the camera. The point in the matrix is determined by determining the average center of intensity by using weights on each pixel dependent on the pixel brightness.

To detect movement in directions normal to the matrix or about an axis, in some examples, the handheld device includes a gyroscope and an accelerometer. In some examples, a gyroscope is a device that uses gravity to help determine orientation. In further examples, the gyroscope can provide rotational data of the handheld device. In further examples, an accelerometer is a device designed to measure non-gravitational acceleration. In some examples, an accelerometer uses microscopic crystals that go under stress when vibrations occur, and from that stress a voltage is generated to create a reading on acceleration.

In some examples, the handheld device sends information relating to the position in the matrix, the gyroscope, and the accelerometer to a receiver, which may be the same unit as the IR apparatus or may be another unit. The receiver receives the positional and movement information and can translate that movement as control inputs to software. In some examples, the software can be a game, physical treatment program, and the like.

It should be appreciated that the above-described subject matter can be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an example spatial detection system.

FIG. 2A-2C are illustrations of a two dimensional matrix used to detect a position of a handheld device.

FIG. 3 is an illustration showing a handheld device.

FIG. 4 is an illustration an example spatial detection system.

FIG. 5 is a flow diagram showing an example routine for operating a spatial detection system.

FIG. 6 is a computer architecture diagram illustrating an illustrative computer hardware and software architecture for a computing system capable of implementing the technologies presented herein.

FIG. 7 is a computer architecture diagram illustrating a computing device architecture capable of implementing aspects of the technologies presented herein.

FIG. 8 is an illustration of a handheld device with a positional attachment.

### DETAILED DESCRIPTION

The following detailed description is directed to technologies for spatial detection system. In some examples, the spatial detection system uses an IR LED and a camera. The camera detects the IR LED and, using the intensity levels of the IR LED, the position of a handheld device in a two-dimensional matrix is determined. The movement of the device can be detected using a gyroscope and/or an accelerometer. The gyroscope is a device that can provide an input to determine orientation as well as rotational data of the handheld device. The accelerometer can provide information relating to the acceleration of the handheld device.

While the subject matter described herein is presented in the general context of program modules that execute in conjunction with the execution of an operating system and application programs on a computer system, those skilled in the art will recognize that other implementations can be performed in combination with other types of program modules. Generally, program modules include routines, programs, components, data structures, and other types of structures that perform particular tasks or implement particular abstract data types. Moreover, those skilled in the art will appreciate that the subject matter described herein can be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific examples. Referring now to the drawings, in which like numerals represent like elements throughout the several figures, aspects of technologies for a spatial detection system will be presented.

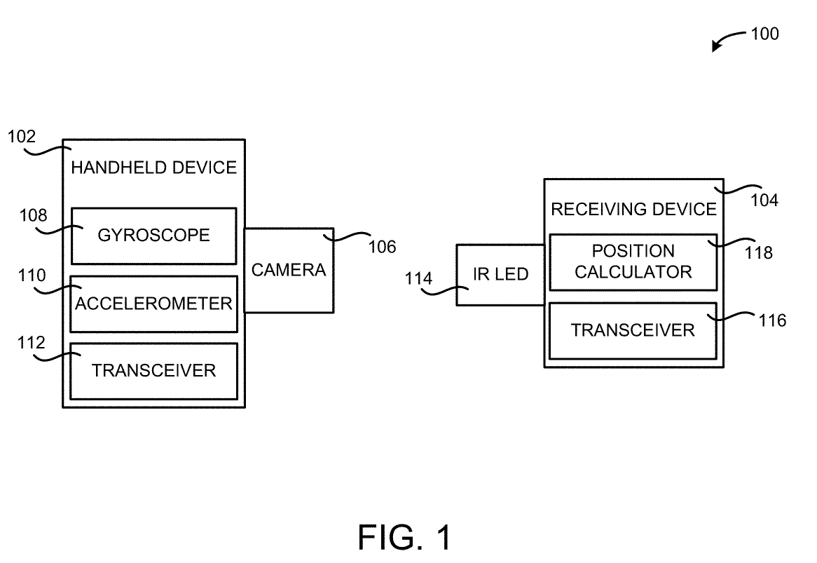

Referring now to FIG. 1, aspects of a spatial detection system 100. The spatial detection system 100 shown in FIG. 1 includes a handheld device 102 and a receiving device 104. In some examples, the handheld device 102 includes a camera 106, a gyroscope 108, an accelerometer 110, and a transceiver 112. In some examples, the camera 106 comprises pixels configured to detect infrared light. The gyroscope 108 and the accelerometer 110 can be used to detect position and movement of the handheld device, explained in more detail below.

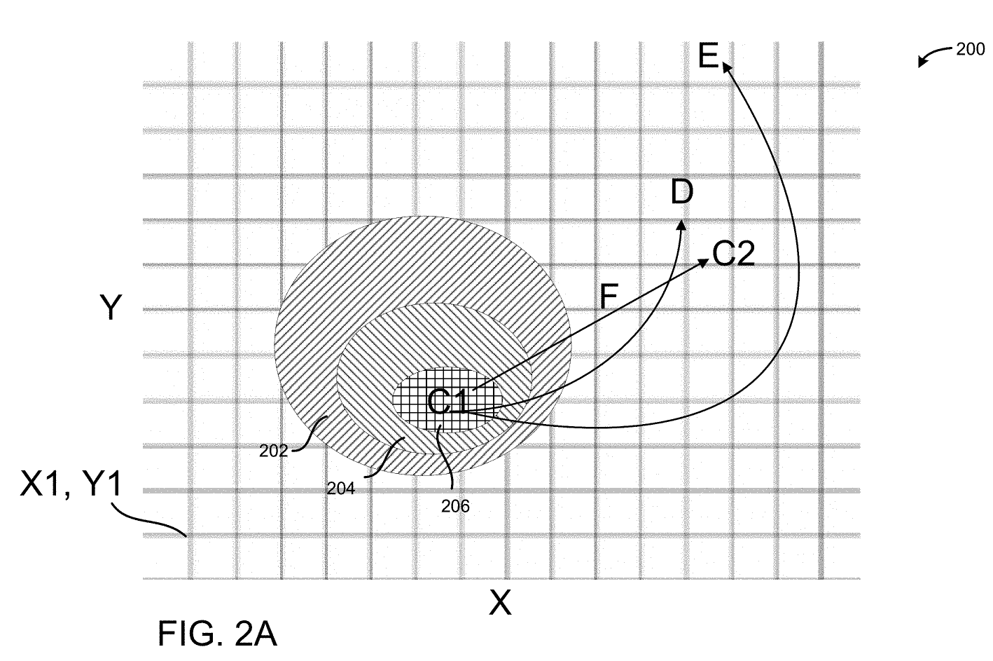

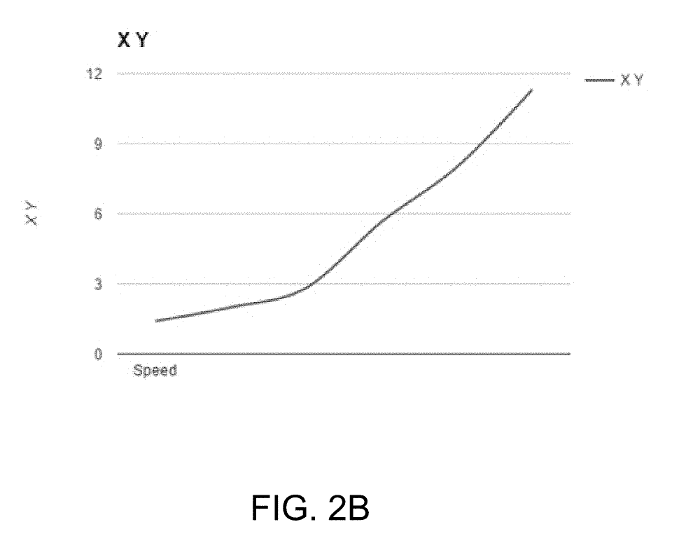

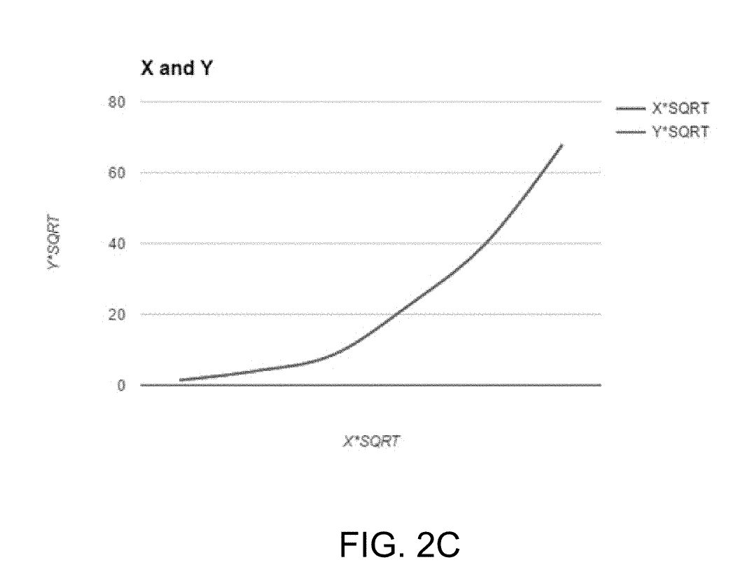

The receiving device 104 includes an IR LED 114 configured to transmit infrared light. During operation, an initial position of the handheld device 102 is determined in a 2D matrix (explained in more detail in FIG. 2A). To determine an initial position of the handheld device 102 in a 2D matrix, the pixels of the camera 106 detect the intensity of the light from the IR LED (also explained in FIG. 2A). The intensity across the several pixels are weighted and averaged to determine a location in the 2D matrix. It should be noted that the camera 106 being illustrated as a component of the handheld device 102 is merely illustrative and an example, as the camera 106 may be associated with other components or may be in other locations, such as the receiving device 104. In a similar manner, the IR LED 114, in other examples, can be a component of the handheld device 102 or be associated with other components or locations.

To determine movement, the handheld device 102 uses the gyroscope and/or the accelerometer 110. Although in some examples, the accelerometer 110 can determine lateral motion fairly accurately, some accelerometers 110 may not determine rotational motion or position. For example, if the handheld device 102 is rotated about an axis, to detect the rotation, in some examples, the outputs of multiple accelerometers 110 would be needed and combined to approximate the rotational motion. Thus, for non-rotational motion and positional information (i.e. back and forth, up and down, and the like), the gyroscope 108 can be used. The gyroscope 108 and the accelerometer 110 can be constructed using conventional technologies.

The outputs from the camera 106, the gyroscope 108, and the accelerometer 110 can be transmitted to the receiving device 104 using the transceiver 112. It should be understood that the outputs from the camera 106, the gyroscope 108, and the accelerometer 110 can be transmitted to the receiving device 104 using various technologies, including Bluetooth, Wi-Fi, or wired connections. The presently disclosed subject matter is not limited to any particular manner of transmitting the information. In some examples, the outputs from the camera 106, the gyroscope 108, and the accelerometer 110 can be transmitted at rates of 100 Hz or more frequently.

The receiving device 104 receives the outputs from the camera 106, the gyroscope 108, and the accelerometer 110 using the transceiver 116. As with the handheld device 102, the receiving device 104 can receive the outputs from the camera 106, the gyroscope 108, and the accelerometer 110 using various communication technologies. A position calculator 118 receives the outputs from the camera 106, the gyroscope 108, and the accelerometer 110 and determines a position, or updates a position translated as movement, of the handheld device 102. In some examples, the position calculator 118 is part of the handheld device 102. In some examples, the position calculator 118 also performs smoothing operations.

In some examples, the control of the handheld device 102 may be modified to include different combinations of sensors. For example, a combined infrared and gyroscope mode may use the IR LED 114/Camera 106 and the gyroscope 108. An example instruction set may be as follows:

| // | |
|---|---|
| var.enablegyro = 1 | |
| //Using enable gyro, you can enable or not the gyro movements. | |
| var.enablehandspeed = 0 | |
| var.gyrospeed = 8 | |
| // Change the “gyro hand” speed, 2: default | |
| var. speed = 4 | |
| //Just select a speed you want, it will be calculated with x and Y. | |
| var.xspeed = 5 | |
| //You can change the vertical speed. 3: default | |
| var.yspeed = 4 | |
| //You can change the horizontal speed. 3: default | |
| var.handspeed = 64 | |
| //Depending the speed of your hand, the movement will get | |
| slighty faster. | |
| var.variation = 0.05 | |
| //Variation betwenn handspeed and ir speed. 0.2: ir slower | |
| than hand | |
| //1: normalspeed (set it to 0.25 if you set var.handspeed to 0) | |
| var.curve = 1.2 | |
| //var.curve change the speed of a distance. 1 = Simple line, | |
| 2 = Rounded curve. Set | |
| bellow 1 for a reversed curve. | |
| var.curve2 = 1 | |
| //Curve2 is for the handspeed, same as first. | |
| var.yawwiispeed = wiimote.MotionPlus.RawyawSpeed | |
| var.pitchwiispeed = wiimote.MotionPlus.RawpitchSpeed | |
| var.positionX = (−wiimote.dot1x + 507)/ 507 | |
| var.positionY = (wiimote.dot1y − 380) / 380 | |
| var.radianSpeed = sqrt((abs(var.positionX)\hat{ }var.curve + | |
| abs(var.positionY)\hat{ }var.curve | |
| )) | |
| var.radianSpeedGyro = sqrt( ( abs(var.yawwiispeed)\hat{ }2 * | |
| var.gyrospeed + | |
| abs(var.pitchwiispeed/2)\hat{ }2 * var.gyrospeed ) )/500 | |
| var.pointx = wiimote.PointerX | |
| var.pointy = wiimote.PointerY | |
| if var.enablegyro = 1 then | |
| var.gyrox = (sign(var.yawwiispeed)* abs(var.yawwiispeed/ | |
| 10) * | |
| var.radianSpeedGyro) | |
| var.gyroy = ((−1 * sign(var.pitchwiispeed)* | |
| abs(var.pitchwiispeed/10) * | |
| var.radianSpeedGyro) ) | |
| else | |
| var.gyrox = 0 | |
| var.gyroy = 0 | |
| endif | |
| if var.enablehandspeed = 1 then | |
| var. radianDeltaSpeed = smooth(abs(delta( sqrt | |
| ((abs(var.positionX)\hat{ }var. curve2 * | |
| 150000 + abs(var.positionY)\hat{ }var.curve2 * | |
| 150000 )) )+ var.variation * 4 * | |
| var.handspeed ), 2) | |
| else | |
| var.radiandeltaspeed = 1 | |
| endif | |
| 'mouse.DirectInput3D = mouse.DirectInput3D + var.positionxyz | |
| | // + (sign(var |

.yawwiispeed)* abs(var.yawwiispeed/10) * var.radianSpeedGyro)
fakemouse.DirectInputX = fakemouse.DirectInputX +
sign(var.positionX) *
abs(var.positionX)* var.radianSpeed * var.xspeed *
var. speed *
var.radianDeltaSpeed + var.gyrox
fakemouse.DirectInputY = fakemouse.DirectInputY +
sign(var.positionY) *
abs(var.positionY)* var.radianSpeed * var.yspeed *
var.speed *
var.radianDeltaSpeed + var.gyroy

Another mode may be railshoot mode. An example set of instructions may be as follows:

```
var.positionx = abs((wiimote.dot1x / 1024) − 1)
var.positiony = wiimote.dot1y / 768
var.test = 1
if starting then
var. speed = 1
pie.FrameRate = 120hz
  var.pointer_t = 0
  var.pointer_b = 0
  var.pointer_1 = 0
  var.pointer_r = 0
  var.modespeed = 3
  var.dpi = pie.MouseDPI
  var.screenposx = screen.Width
  var.screenposy = screen.Height
  var.gyrospeed = 0
  var.smoothfps = 30
  var.smoothafterspeed = 5
  var.countX = 1
endif
var.deltafastx = abs(delta(wiimote.dot1x ))
var.deltafasty = abs(delta(wiimote.dot1y ))
var.radiandelta = smooth(abs(var.deltafastx) * abs(var.deltafasty )) + 5
var.smoothdelta = int(50 / var.radiandelta ) + 2
var.mousex = mouse.x
var. smooth = 1
var.mousey = mouse.y * var.screenposy
if var.pointer_t != 0 and var.pointer_b != 0 and var.pointer_r != 0
and var.pointer_l !=
0 then
    debug = “Everythings is ok. Pointer _l = ” + var.pointer_l +
“ Pointer _r = ” +
var.pointer_r + “ Pointer_t ” + var.pointer_l + “ Pointer _b ”
+ var.pointer b + “.”
  var.smoothX = int(var.smoothdelta)
  //mouse.x = Smooth(var.tryx1, 10)
  else
debug = “No calibration found. Press LEFT to select the
top left corner and right for
the bottom right corner.”
endif
  //var.syncy = (var.syncy + var.tryx1 ) / var.smoothfps
if wiimote.Left then
var.pointer_t = var.positiony
var.pointer_l = var.positionx
endif
if wiimote.Right then
var.pointer_b = var.positiony
var.pointer_r = var.positionx
endif
var.keepoldx = var.tryx1
var.tryx1 = EnsureMapRange(var.positionx, var. pointer_1,
var. pointer_r, 0, 1)
var.tryy1 = EnsureMapRange(var.positiony, var.pointer_t,
var.pointer_b, 0, 1)
if var.smoothdelta > 7 then
var.modespeed = 1
endif
if var.smoothdelta < 7 then
var.modespeed = 3
endif
if var.slowp < 15 then
  var. syncx1 = (var. syncx1 + var.tryx1 )
  var. syncx11 = var. syncx1 / 15
  var. syncy1 = (var. syncy1 + var.tryy1 )
  var. syncy11 = var. syncy1 / 15
var. slowp++
else
  var. syncx1 = var. syncx1 − var. syncx11
  var. syncy1 = var. syncy1 − var. syncy11
var. slowp--
endif
if var.fastp < 2 then
  var. syncx3 = (var. syncx3 +var.tryx1 )
  var. syncx33 = var. syncx3 / 2
  var. syncy3 = (var. syncy3 +var.tryyl )
  var. syncy33 = var. syncy3 / 2
var.fastp++
else
    var. syncx3 = var. syncx3 − var.syncx33
    var. syncy3 = var. syncy3 − var.syncy33
var.fastp--
endif
var.valuefast = var. slowp / var.fastp
if var.modespeed = 1 then
mouse.x = var.syncx11
mouse.y = var.syncy33
var.syncx3 = var.syncx1 / var.valuefast
var.syncy3 = var.syncy1 / var.valuefast
endif
if var.modespeed = 3 then
mouse.x = var.syncx33
mouse.y = var.syncy33
var.syncx1 = var.syncx3 * var.valuefast
var.syncy1 = var.syncy3 * var.valuefast
endif
```

Another mode that may be used is the mode in which only infrared is used. An example instruction set may be as follows:

| pie.FrameRate = 250hz | |
|---|---|
| //NEW: Var.offset, set in pixels, min −388, max 380 | |
| // Lower values for led on the top of screen | |
| // Higher values for led on the bottom of screen | |
| // I will recommend to not get more than 100 or −100. | |
| var.offset = 0 | |
| var.curve = 1.1 | |
| var.curve2 = 2 | |
| var.rspeed = 1.2 | |
| var.rspeed2 = 1.6 | |
| var.yspeed = 0.85 | |
| if var.ledenable = 1 then | |
| var.positionX = (−wiimote.dot1x +507) | |
| var.positionY = (wiimote.dot1y − 380 + var. offset) | |
| var.WrapX = smooth(−1 * var.positionX , 2) | |
| var.WrapY = smooth(−1 * var.positionY , 2) | |
| var.newcenterx = ( var.positionX + var.WrapX )/ 20 * 3 | |
| var.newcentery = (var.positionY + var.WrapY )/ 20 * 3 | |
| var. radian Speed0 = sqrt((abs(var.newcenterx) + | |
| abs(var.newcentery) )) | |
| var. radian Speed = sqrt((abs(var.newcenterx)\hat{ }var. curve + | |
| abs(var.newcentery * | |
| var.yspeed)\hat{ }var. curve)) * var.rspeed | |
| var. radian Speed2 = sqrt((ab s(var.positionX)\hat{ }var.curve2 + | |
| abs(var.positionY * | |
| var.yspeed)\hat{ }var.curve2 )) * var.rspeed2 | |
| var.radianSpeed3 = sqrt((ab s(var.positionX) + | |
| abs(var.positionY) )) | |
| | // + (sign(var |

.yawwiispeed)* abs(var.yawwiispeed/10) *
var.radianSpeedGyro)
fakemouse.DirectInputX = fakemouse.DirectInputX +
((sign(var.newcenterx) *
abs(var.newcenterx)* var. radian Speed ) * 1.5 ) +
((sign(var.newcenterx) *
abs(var.newcenterx)* var. radian Speed ) * 3 ) +
(sign(var.positionX) *
abs(var.positionX)* var.radianSpeed2 /6400 ) +
(sign(var.positionX) *
abs(var.positionX)* var.radianSpeed3 /12400)
fakemouse.DirectInputY = fakemouse.DirectInputY +
(sign(var.newcentery) *
abs(var.newcentery)* var.radianSpeed0 ) * 1.5 ) +
((sign(var.newcentery) *
abs(var.newcentery)* var.radianSpeed ) * 3 ) +
(sign(var.positionY) *
abs(var.positionY)* var.radianSpeed2 / 6400 ) +
(sign(var.positionY) *
abs(var.positionY)* var.radianSpeed3 / 12400)
else
endif

FIG. 2A is an illustration of a two-dimensional (“2D”) matrix 200 used to detect a position of the handheld device 102. The 2D matrix 200 is formed by the pixels of the camera 106. An example pixel is X1, Y1. It should be understood that the number of pixels in FIG. 2A is provided only for purposes of illustration, as some cameras 106 can include fewer or more pixels, and would be suitable for use within the scope presently disclosed subject matter.

The 2D matrix 200 includes an X axis and a Y axis. In some examples, the 2D matrix 200 is designed to simulate a plane parallel to the force vector of gravitational acceleration. Thus, the 2D matrix 200 can be used to establish a location of the handheld device 102 in a space. To determine the location, the intensity of the IR LED 114 is detected at the camera 106. In an example, the camera 106 has detected the IR LED 114. The pixels in the area covered by intensity 202 have detected low intensity levels. The pixels in the area covered by intensity 204 have detected medium intensity levels. The pixels in the area covered by intensity 206 have detected high intensity levels. It should be understood that the intensity change from intensity 202 to 204 to 206 will mostly likely be a gradual change. The change illustrated in FIG. 2A is only for purposes of an example.

To determine a center C1 of the IR LED 114 on the camera 106, various technologies can be used. For example, the pixel of the camera with the highest intensity light can be designated as the location of the IR LED 114 in the 2D matrix 200. In other examples, the intensities can be averaged to determine the center C1. The presently disclosed subject matter is not limited to any particular technology for determining the center C1.

In some examples, detecting position using the 2D matrix 200 can provide acceptable inputs to determine a location. However, being a Cartesian coordinate system, outputs provided only using the 2D matrix 200 can, in some examples, provide less than optimal outputs during the movement of the handheld device 102. For example, if the number of pixels of the camera 106 is not of a degree that can provide highly accurate IR LED intensity detection, the resulting outputs may create a stepping or jerky motion in an application in which the handheld device 102 is being used. A stepping motion is one in which the motion of the handheld device 102 is detected as moving almost instantaneously from one location to another. A jerky motion is one in which the motion of the handheld device 102 appears erratic or does not move in concert with the movement of the handheld device 102.

Other types of movement issues may occur. For example, a human using the handheld device 102 may not have steady hands or may be limited in motion. In the instance in which a user may have unsteady hands, or other instances such as when a user may not be experienced using the handheld device 102, movements of the user may be unintentional and may cause unexpected or unintentional movements in a software application used in conjunction with the handheld device 102.

In these and other examples, the movement of the handheld device 102 in the 2D matrix 200 may be smoothed. In some examples, the movement of the handheld device 102 may be measured along curves in the 2D matrix 200 using the Cartesian coordinates provide by the camera 106. In FIG. 2A, example curve D and example curve E are illustrated. The curve D may be represented by the equation, y=x̂1.2. The curve E may be represented by the equation, y=x̂3. The equations are merely exemplary, as other curves may be used. Further, the number of curves may be increased or decreased, with two being merely an example in which two curves are used.

In the example illustrated in FIG. 2A, the handheld device 102 has moved from center C1 to center C2 along line F. If using the Cartesian coordinates established by the pixels of the camera 106, the movement along the pixels may create undesirable movements from center C1 to center C2. To smooth the motion from center C1 to center C2, the motion of the handheld controller is measured along the curves D and E, rather than only along the line F.

Below are example instructions that may be used to provide smoothing using arc measurements. It should be noted that set points are merely exemplary.

var.curve = 1.2
var.curve2 = 3
var.positionX = (−wiimote.dot1x +512)
var.positionY = (wiimote.dot1y − 384)
var.WrapX = smooth(−1 * var.positionX , 2)
var.WrapY = smooth(−1 * var.positionY, 2)
varnewcenterx = ( var.positionX + var.WrapX ) / 20 * 10
var.newcentery = (var.positionY + var.WrapY )/ 20 * 10
var.radianSpeed=sqrt((abs(var.newcenterx)\hat{ }var.curve
+abs(var.newcentery)\hat{ }var.curve ))
var.radianSpeed2=sqrt((abs(var.positionX)\hat{ }var.curve2
+ abs(var.positionY)\hat{ }var.curve2 ))
fakemouse.DirectInputX = fakemouse.DirectInputX +
((sign(var.newcenterx) *
abs(var.newcenterx)* var.radianSpeed ) * 1.6 ) + (sign(var.positionX) *
abs(var.positionX)* var.radianSpeed2 /24400)
fakemouse.DirectInputY = fakemouse.DirectInputY +
((sign(var.newcentery) *
abs(var.newcentery)* var.radianSpeed ) * 1.6 ) + (sign(var.positionY) *
abs(var.positionY)* var.radianSpeed2 / 24400)
© 2016 De la Cuadra, LLC

The determination of location may be done at different periods depending on various factors, including the smoothing type desired. In some examples, two smoothing modes may be provided by the following instructions:

```
if var.smoothdelta > 7 then
var.modespeed = 1
endif
if var.smoothdelta < 7 then
var.modespeed = 3
endif
if var.slowp < 15 then
  var.syncx1 = (var. syncx1 + var.tryx1 )
  var.syncx11 = var. syncx1 / 15
  var.syncy1 = (var. syncy1 + var.tryy1 )
  var.syncy11 = var. syncy1 / 15
var.slowp++
else
  var.syncx1 = var.syncx1 − var. syncx11
  var. syncy1 = var. syncy1 − var. syncy11
var. slowp--
endif
if var.fastp < 2 then
  var.syncx3 = (var.syncx3 + var.tryx1 )
  var.syncx33 = var.syncx3 / 2
  var.syncy3 = (var.syncy3 + var.tryyl )
  var.syncy33 = var.syncy3 / 2
var.fastp++
else
  var.syncx3 = var.syncx3 − var. syncx33
  var.syncy3 = var.syncy3 − var. syncy33
var.fastp--
endif
if var.modespeed = 1 then
mouse.x = var. syncx11
mouse.y = var. syncy33
var.syncx3 = var. syncx1 / var.valuefast
var.syncy3 = var. syncy1 / var.valuefast
endif
if var.modespeed = 3 then
mouse.x = var. syncx33
mouse.y = var. syncy33
var.syncx1 = var.syncx3 * var.valuefast
var.syncy1 = var.syncy3 * var.valuefast
endif
©2016 De la Cuadra, LLC
```

In the example provided above, the movement of the handheld device 102 will change depending on the speed of the movement, resulting in a change in speed that is reflective of current conditions, or “real time.”

In some conventional devices, when the handheld device 102 is moved in the 2D matrix 200, the X (horizontal) and Y (vertical) values in the 2D matrix 200 are measured in the 2D matrix 200 separately. In some examples of the presently disclosed subject matter, to determine movement (as opposed to position described above), the movement of the handheld device 102 is measured within a matrix using radians. In some examples of the presently disclosed subject matter, a line is provided for both values (X and Y), and provided with a value called RADIANS (see e.g. the software instructions provided above). An example is provided in FIG. 2B. The final value will follow the same curve, for X and Y (Radian * X, Radian * Y). An example is provided in FIG. 2C. Thus, in some examples, the X and Y various established in the 2D matrix can be calculated at the same time.

In some examples, the position of the handheld device 102 can be determined using inputs other than or in addition to the camera 106. For example, the gyroscope 108 can be used as a location input along with the camera 106 to determine the movement of the handheld device 102 in the 2D matrix 200. For example, the camera 106 may provide granular detection of the location of the handheld device 102 in the matrix from location 1 to location 2, whereas the gyroscope may be able to provide location in a fine granular manner from 1 to 1.1 to 1.2 and so forth. The accelerometer 110 may be used to determine location along vectors normal to the 2D matrix, i.e. forward and backward motion. In some examples, the gyroscope 108 may also provide forward and backward motion input as well as rotational input.

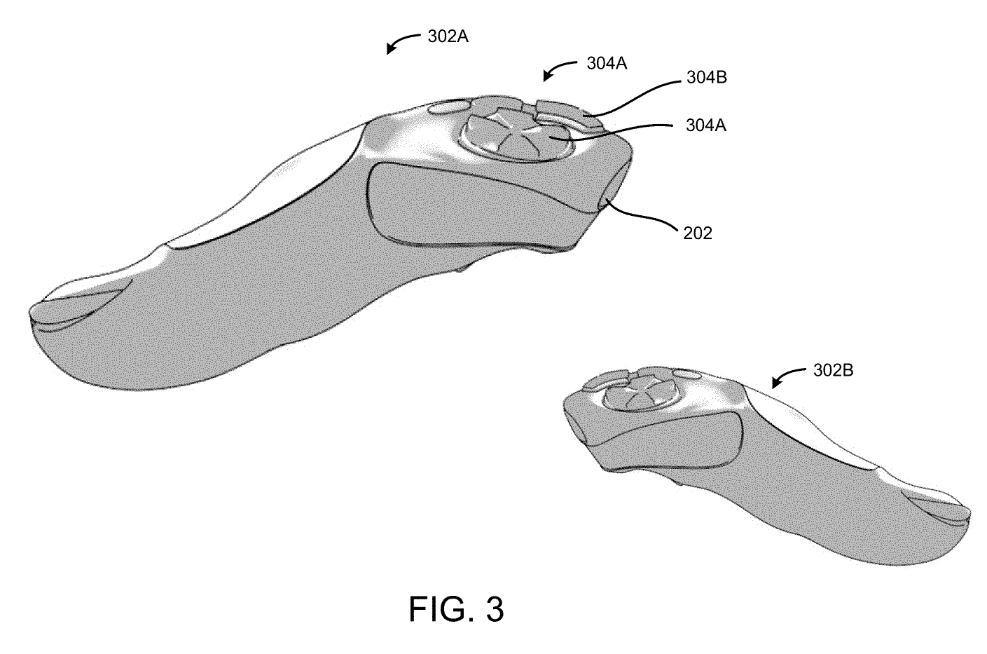

FIG. 3 is an example handheld device 302A that may be used in conjunction with various examples of the presently disclosed subject matter. In FIG. 3, the handheld device 302A includes the camera 106. Housed within the handheld device 302A are the gyroscope 108 (not shown) and the accelerometer 110 (not shown). In some examples, a second handheld device 302B, similar in functionality to the handheld device 302 A, may be used in conjunction with the handheld device 302A.

For example, the handheld device 302A may be a device configured for use by the left hand of a user and the handheld device 302B may be configured for use by the right hand of the user. In other examples, the handheld device 302A may be a device that is moved by the user in three dimensions, whereas the handheld device 302B may be a device that is moved in two dimensions, such as a mouse. The presently disclosed subject matter is not limited to any particular configuration.

The handheld device 302A, as well as the handheld device 302B, may include control inputs 304. The control inputs 304 may include a directional control 304A and a selection control 304B. It should be noted that the control inputs 304 illustrated in FIG. 3 are merely examples, as other control inputs 304 may be used and are considered to be within the scope of the presently disclosed subject matter.

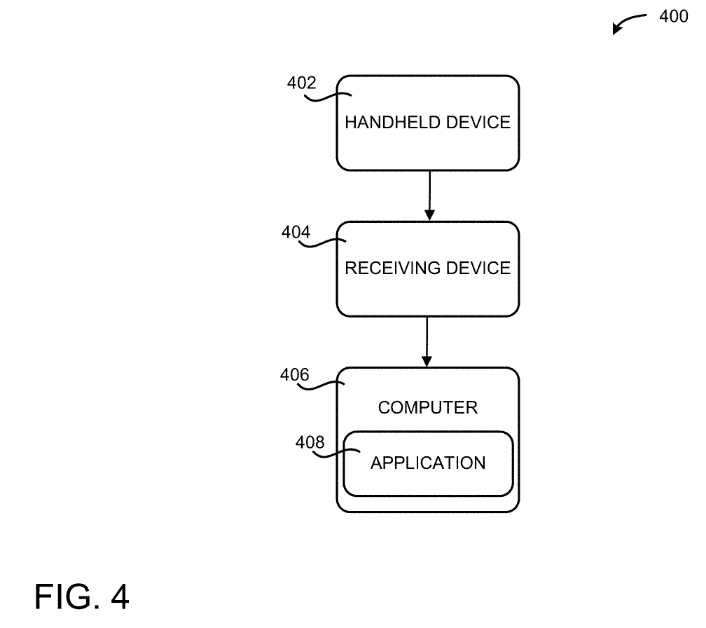

FIG. 4 is an example spatial detection system 400 that may be used to provide a location and/or a motion input to a software application. The spatial detection system 400 includes a handheld device 402 and a receiving device 404. The receiving device 404 receives positional information from the handheld device 402 and provides position and movement information to a computer 406. The computer 406 can execute an application 408 that uses the position and movement information as inputs.

For example, the application may be a game in which the position and movement information are used as inputs to control a weapon, a player, and the like. In other examples, the application may be a healthcare application in which users use the handheld device 402 to control simulated objects generated by the application 408. The presently disclosed subject matter is not limited to any particular type of application.

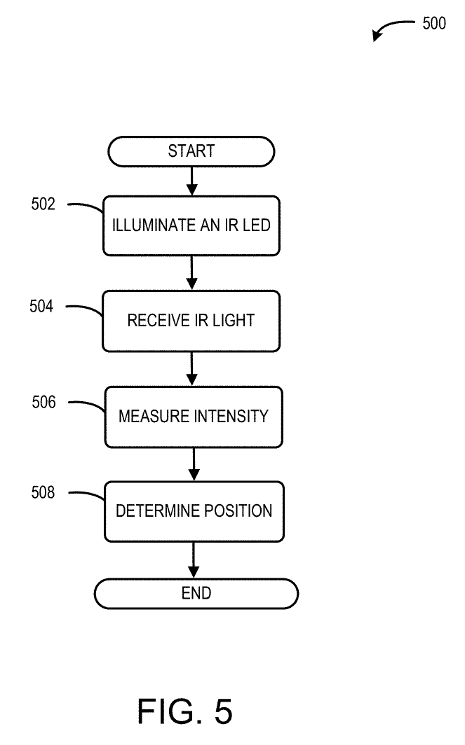

FIG. 5 is a flow diagram showing aspects of a method 500 for operating a spatial detection system. It should be understood that the operations of the method 500 are not necessarily presented in any particular order and that performance of some or all of the operations in an alternative order(s) is possible and is contemplated. The operations have been presented in the demonstrated order for ease of description and illustration. Operations can be added, omitted, and/or performed simultaneously, without departing from the scope of the appended claims.

It also should be understood that the illustrated method 500 can be ended at any time and need not be performed in its entirety. Some or all operations of the method 500, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Computer-storage media does not include transitory media.

Thus, it should be appreciated that the logical operations described herein can be implemented as a sequence of computer implemented acts or program modules running on a computing system, and/or as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules can be implemented in software, in firmware, in special purpose digital logic, and any combination thereof.

For purposes of illustrating and describing the technologies of the present disclosure, the method 500 disclosed herein is described as being performed by the spatial detection system 400. While the method 500 is described as being provided by the spatial detection system 400, it should be understood that the functionality described herein can be provided by various devices via execution of various application program modules and/or elements. Additionally, devices other than, or in addition to, the spatial detection system 400 can be configured to provide the functionality described herein via execution of computer executable instructions other than, or in addition to, the spatial detection system 400. As such, it should be understood that the described configuration is illustrative, and should not be construed as being limiting in any way.

The method 500 begins at operation 502, where an IR LED 114 is illuminated. In some examples, the receiving device 104 includes the IR LED 114. In other examples, the handheld device 102 includes the IR LED 114. In further examples, another device (not shown) provides the IR LED 114. The presently disclosed subject matter is not limited to any particular device for providing the IR LED 114.

The method 500 continues to operation 504, where the IR light from the IR LED 114 is received at the camera 106. In some examples, the receiving device 104 includes the camera 106. In those examples, the IR LED 114 may be provided by the handheld device 102 or another device. In other examples, the handheld device 102 includes the camera 106. In those examples, the IR LED 114 may be provided by the receiving device 104 or another device. In further examples, another device (not shown) provides the camera 106. The presently disclosed subject matter is not limited to any particular device for providing the camera 106.

The method 500 continues to operation 506, where an intensity is measured at the pixels of the camera 106. In some examples, the IR LED 114 is a single IR light source. Because of the manner in which light travels from the illuminating source, the intensity of the IR light on the pixels of the camera 106 will vary across the pixels of the camera 106.

The method 500 continues to operation 508, where the position of the handheld device 102 is determined. In some examples, the pixel of the camera with the highest intensity light can be designated as the location of the IR LED 114 in the 2D matrix 200. In other examples, the intensities can be averaged to determine the center C1. The presently disclosed subject matter is not limited to any particular technology for determining the center C1. Thereafter, the method 500 can end.

The present disclosure also encompasses the subject matter set forth in the following clauses:

Clause 1:A method of determining a position of a handheld device, the method comprising: receiving, at a camera comprising a plurality of pixels, light waves from an infrared (IR) light emitting diode (LED); measuring a plurality of intensities of the light waves at the plurality of pixels; and determining the position of the handheld device in a two-dimensional matrix based on the measured plurality of intensities of the light waves at the plurality of pixels.

Clause 2. The method of clause 1, wherein the pixels of the camera establish the two-dimensional matrix.

Clause 3. The method of any of clauses 1-2, wherein determining the position of the handheld device based on the measured plurality of intensities of the light waves at the plurality of pixels comprises weighting and averaging the plurality of intensities across the plurality of pixels.

Clause 4. The method of any of clauses 1-3, further comprising determining non-rotational movement or positional information of the handheld device using a gyroscope.

Clause 5. The method of any of clauses 1-4, further comprising determining lateral motion information using an accelerometer.

Clause 6. The method of any of clauses 1-5, further comprising transmitting the position, the non-rotational movement or positional information, or the lateral motion information of the handheld device to a receiving device for use in a game or medical application.

Clause 7. The method of any of clauses 1-6, further comprising smoothing a detected movement from the position to a second position by measuring the movement from the position to the second position along a plurality of curves.

Clause 8. The method of any of clauses 1-7, wherein horizontal and vertical values in the two-dimensional matrix are calculated at the same time using radians.

Clause 9. A handheld device, comprising: a camera comprising a plurality of pixels in a two-dimensional matrix configured to receive light waves from an infrared (IR) light emitting diode (LED); a position calculator configured to: measure a plurality of intensities of the light waves at the plurality of pixels; and determine the position of the handheld device in the two-dimensional matrix based on the measured plurality of intensities of the light waves at the plurality of pixels.

Clause 10. The handheld device of clause 9, wherein the pixels of the camera establish the two-dimensional matrix.

Clause 11. The handheld device of any of clauses 9-10, wherein determining the position of the handheld device based on the measured plurality of intensities of the light waves at the plurality of pixels comprises weighting and averaging the plurality of intensities across the plurality of pixels.

Clause 12. The handheld device of any of clauses 9-11, further comprising a gyroscope to determine non-rotational movement or positional information of the handheld device.

Clause 13. The handheld device of any of clauses 9-12, further comprising an accelerometer to determine lateral motion information.

Clause 14. The handheld device of any of clauses 9-13, further comprising a positional attachment, the positional attachment comprising a plurality of light sources to provide positional information.

Clause 15. The handheld device of any of clauses 9-14, wherein the position calculator is further configured to smooth a detected movement from the position to a second position by measuring the movement from the position to the second position along a plurality of curves.

Clause 16. The handheld device of any of clauses 9-15, wherein horizontal and vertical values in the two-dimensional matrix are calculated at the same time using radians.

Clause 17. A non-transitory computer-readable storage medium having instructions stored thereupon which, when executed by the processor, cause the processor to: receive, at a camera comprising a plurality of pixels, light waves from an infrared (IR) light emitting diode (LED); measure a plurality of intensities of the light waves at the plurality of pixels; and determine the position of the handheld device in a two-dimensional matrix based on the measured plurality of intensities of the light waves at the plurality of pixels.

Clause 18. The non-transitory computer-readable storage medium of clause 17, wherein the computer-executable instructions to determine the position of the handheld device based on the measured plurality of intensities of the light waves at the plurality of pixels comprises instructions to weight and average the plurality of intensities across the plurality of pixels.

Clause 19. The non-transitory computer-readable storage medium of any of clauses 17-18, further comprising computer-executable instructions to smooth a detected movement from the position to a second position by measuring the movement from the position to the second position along a plurality of curves.

Clause 20. The non-transitory computer-readable storage medium of any of clauses 17-19, wherein horizontal and vertical values in the two-dimensional matrix are calculated at the same time using radians.

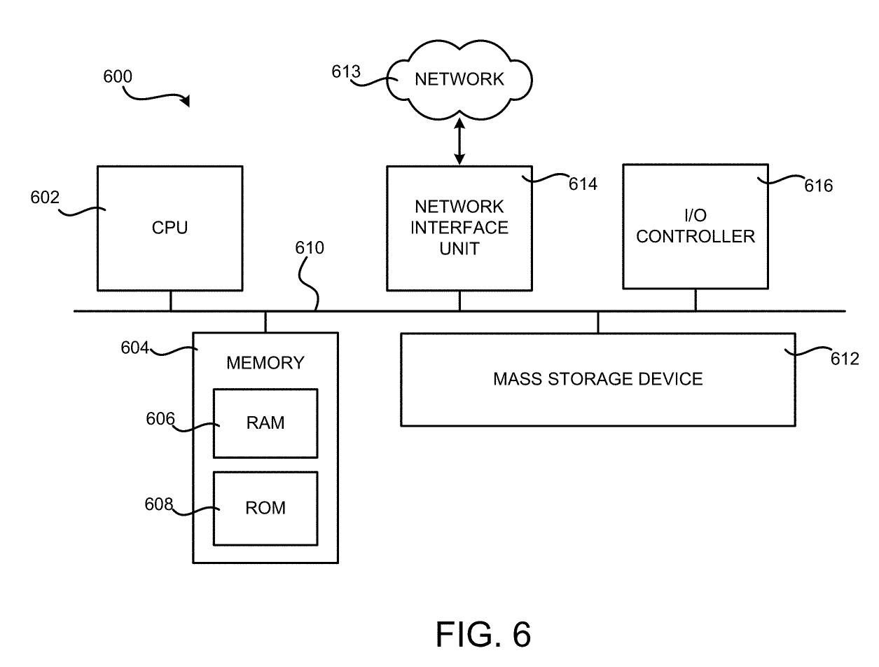

FIG. 6 illustrates an illustrative computer architecture 600 for a device capable of executing the software components described herein for operating a spatial detection system. Thus, the computer architecture 600 illustrated in FIG. 6 illustrates an architecture for a server computer, mobile phone, a smart phone, a desktop computer, a netbook computer, a tablet computer, and/or a laptop computer. The computer architecture 600 can be utilized to execute any aspects of the software components presented herein.

The computer architecture 600 illustrated in FIG. 6 includes a central processing unit 602 (“CPU”), a system memory 604, including a random access memory 606 (“RAM”) and a read-only memory (“ROM”) 608, and a system bus 610 that couples the memory 604 to the CPU 602.A basic input/output system containing the basic routines that help to transfer information between elements within the computer architecture 600, such as during startup, is stored in the ROM 608. The computer architecture 600 further includes a mass storage device 612 for storing data and applications.

The mass storage device 612 is connected to the CPU 602 through a mass storage controller (not shown) connected to the bus 610. The mass storage device 612 and its associated computer-readable media provide non-volatile storage for the computer architecture 600. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media can include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 600. For purposes of the claims, a “computer storage medium” or “computer-readable storage medium,” and variations thereof, do not include waves, signals, and/or other transitory and/or intangible communication media, per se. For the purposes of the claims, “computer-readable storage medium,” and variations thereof, refers to one or more types of articles of manufacture.

According to various configurations, the computer architecture 600 can operate in a networked environment using logical connections to remote computers through a network such as the network 613. The computer architecture 600 can connect to the network 613 through a network interface unit 614 connected to the bus 610. It should be appreciated that the network interface unit 614 can also be utilized to connect to other types of networks and remote computer systems.

The computer architecture 600 can also include an input/output controller 616 for receiving and processing input from a number of other devices, including a keyboard, mouse, or electronic stylus (not shown in FIG. 6). Similarly, the input/output controller 616 can provide output to a display screen, a printer, or other type of output device (also not shown in FIG. 6).

It should be appreciated that the software components described herein can, when loaded into the CPU 602 and executed, transform the CPU 602 and the overall computer architecture 600 from a general-purpose computing system into a special-purpose computing system customized to facilitate the functionality presented herein. The CPU 602 can be constructed from any number of transistors or other discrete circuit elements, which can individually or collectively assume any number of states. More specifically, the CPU 602 can operate as a finite-state machine, in response to executable instructions contained within the software modules disclosed herein. These computer-executable instructions can transform the CPU 602 by specifying how the CPU 602 transitions between states, thereby transforming the transistors or other discrete hardware elements constituting the CPU 602.

Encoding the software modules presented herein can also transform the physical structure of the computer-readable media presented herein. The specific transformation of physical structure can depend on various factors, in different implementations of this description. Examples of such factors can include, but are not limited to, the technology used to implement the computer-readable media, whether the computer-readable media is characterized as primary or secondary storage, and the like. For example, if the computer-readable media is implemented as semiconductor-based memory, the software disclosed herein can be encoded on the computer-readable media by transforming the physical state of the semiconductor memory. For example, the software can transform the state of transistors, capacitors, or other discrete circuit elements constituting the semiconductor memory. The software also can transform the physical state of such components in order to store data thereupon.

As another example, the computer-readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 600 in order to store and execute the software components presented herein. It also should be appreciated that the computer architecture 600 can include other types of computing devices, including hand-held computers, embedded computer systems, personal digital assistants, and other types of computing devices known to those skilled in the art. It is also contemplated that the computer architecture 600 might not include all of the components shown in FIG. 6, can include other components that are not explicitly shown in FIG. 6, or might utilize an architecture completely different than that shown in FIG. 6.

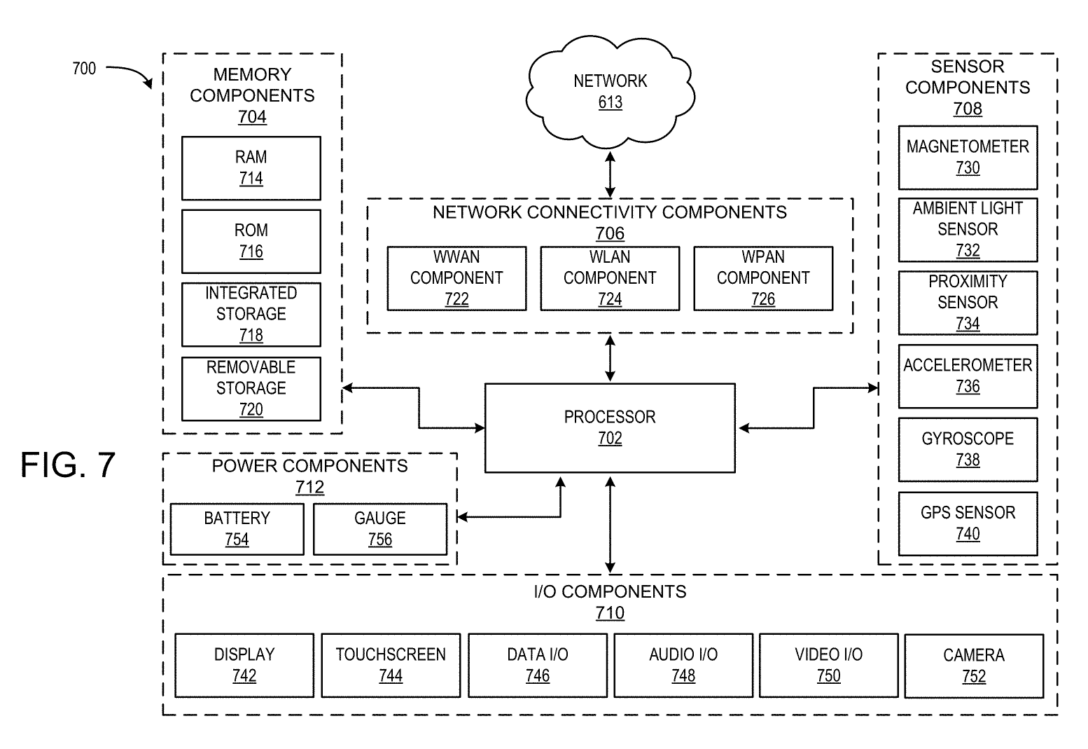

Turning now to FIG. 7, an illustrative computing device architecture 700 for a computing device that is capable of executing various software components described herein for operating a spatial detection system is described. The computing device architecture 700 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like. Moreover, the computing device architecture 700 is applicable to any of the clients 706 shown in FIG. 7. Furthermore, aspects of the computing device architecture 700 can be applicable to traditional desktop computers, portable computers (e.g., laptops, notebooks, ultra-portables, and netbooks), server computers, and other computer systems, such as described herein with reference to FIG. 6. For example, the single touch and multi-touch aspects disclosed herein below can be applied to desktop computers that utilize a touchscreen or some other touch-enabled device, such as a touch-enabled track pad or touch-enabled mouse.

The computing device architecture 700 illustrated in FIG. 7 includes a processor 702, memory components 704, network connectivity components 706, sensor components 708, input/output components 710, and power components 712. In the illustrated configuration, the processor 702 is in communication with the memory components 704, the network connectivity components 706, the sensor components 708, the input/output (“I/O”) components 710, and the power components 712. Although no connections are shown between the individual components illustrated in FIG. 7, the components can interact to carry out device functions. In some configurations, the components are arranged so as to communicate via one or more busses (not shown).

The processor 702 includes a central processing unit (“CPU”) configured to process data, execute computer-executable instructions of one or more application programs, and communicate with other components of the computing device architecture 700 in order to perform various functionality described herein. The processor 702 can be utilized to execute aspects of the software components presented herein and, particularly, those that utilize, at least in part, a touch-enabled input.

In some configurations, the processor 702 includes a graphics processing unit (“GPU”) configured to accelerate operations performed by the CPU, including, but not limited to, operations performed by executing general-purpose scientific and engineering computing applications, as well as graphics-intensive computing applications such as high resolution video (e.g., 720 P, 1080 P, and greater), video games, three-dimensional (“3D”) modeling applications, and the like. In some configurations, the processor 702 is configured to communicate with a discrete GPU (not shown). In any case, the CPU and GPU can be configured in accordance with a co-processing CPU/GPU computing model, wherein the sequential part of an application executes on the CPU and the computationally-intensive part is accelerated by the GPU.

In some configurations, the processor 702 is, or is included in, a system-on-chip (“SoC”) along with one or more of the other components described herein below. For example, the SoC can include the processor 702, a GPU, one or more of the network connectivity components 706, and one or more of the sensor components 708. In some configurations, the processor 702 is fabricated, in part, utilizing a package-on-package (“PoP”) integrated circuit packaging technique. Moreover, the processor 702 can be a single core or multi-core processor.

The processor 702 can be created in accordance with an ARM architecture, available for license from ARM HOLDINGS of Cambridge, United Kingdom. Alternatively, the processor 702 can be created in accordance with an ×86 architecture, such as is available from INTEL CORPORATION of Mountain View, Calif. and others. In some configurations, the processor 702 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 704 include a random access memory (“RAM”) 714, a read-only memory (“ROM”) 716, an integrated storage memory (“integrated storage”) 718, and a removable storage memory (“removable storage”) 720. In some configurations, the RAM 714 or a portion thereof, the ROM 716 or a portion thereof, and/or some combination the RAM 714 and the ROM 716 is integrated in the processor 702. In some configurations, the ROM 716 is configured to store a firmware, an operating system or a portion thereof (e.g., operating system kernel), and/or a bootloader to load an operating system kernel from the integrated storage 718 or the removable storage 720.

The integrated storage 718 can include a solid-state memory, a hard disk, or a combination of solid-state memory and a hard disk. The integrated storage 718 can be soldered or otherwise connected to a logic board upon which the processor 702 and other components described herein can also be connected. As such, the integrated storage 718 is integrated in the computing device. The integrated storage 718 is configured to store an operating system or portions thereof, application programs, data, and other software components described herein.

The removable storage 720 can include a solid-state memory, a hard disk, or a combination of solid-state memory and a hard disk. In some configurations, the removable storage 720 is provided in lieu of the integrated storage 718. In other configurations, the removable storage 720 is provided as additional optional storage. In some configurations, the removable storage 720 is logically combined with the integrated storage 718 such that the total available storage is made available and shown to a user as a total combined capacity of the integrated storage 718 and the removable storage 720.

The removable storage 720 is configured to be inserted into a removable storage memory slot (not shown) or other mechanism by which the removable storage 720 is inserted and secured to facilitate a connection over which the removable storage 720 can communicate with other components of the computing device, such as the processor 702. The removable storage 720 can be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 704 can store an operating system. According to various configurations, the operating system includes, but is not limited to, WINDOWS MOBILE OS from Microsoft Corporation of Redmond, Wash., WINDOWS PHONE OS from Microsoft Corporation, WINDOWS from Microsoft Corporation, BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 706 include a wireless wide area network component (“WWAN component”) 722, a wireless local area network component (“WLAN component”) 724, and a wireless personal area network component (“WPAN component”) 726. The network connectivity components 706 facilitate communications to and from a network 613, which can be a WWAN, a WLAN, or a WPAN. Although a single network 613 is illustrated, the network connectivity components 706 can facilitate simultaneous communication with multiple networks. For example, the network connectivity components 706 can facilitate simultaneous communications with multiple networks via one or more of a WWAN, a WLAN, or a WPAN.

The network 613 can be a WWAN, such as a mobile telecommunications network utilizing one or more mobile telecommunications technologies to provide voice and/or data services to a computing device utilizing the computing device architecture 700 via the WWAN component 722. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 613 can utilize various channel access methods (which might or might not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 613 can be configured to provide voice and/or data communications with any combination of the above technologies. The network 613 can be configured to or adapted to provide voice and/or data communications in accordance with future generation technologies.

In some configurations, the WWAN component 722 is configured to provide dual- multi-mode connectivity to the network 613. For example, the WWAN component 722 can be configured to provide connectivity to the network 613, wherein the network 613 provides service via GSM and UMTS technologies, or via some other combination of technologies. Alternatively, multiple WWAN components 722 can be utilized to perform such functionality, and/or provide additional functionality to support other non-compatible technologies (i.e., incapable of being supported by a single WWAN component). The WWAN component 722 can facilitate similar connectivity to multiple networks (e.g., a UMTS network and an LTE network).

The network 613 can be a WLAN operating in accordance with one or more Institute of Electrical and Electronic Engineers (“IEEE”) 802.11 standards, such as IEEE 802.11 a, 802.11 b, 802.11 g, 802.11 n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 724 is configured to connect to the network 613 via the WI-FI access points. Such connections can be secured via various encryption technologies including, but not limited, WI-FI Protected Access (“WPA”), WPA2, Wired Equivalent Privacy (“WEP”), and the like.

The network 613 can be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 726 is configured to facilitate communications with other devices, such as peripherals, computers, or other computing devices via the WPAN.

The sensor components 708 include a magnetometer 730, an ambient light sensor 732, a proximity sensor 734, an accelerometer 736, a gyroscope 738, and a Global Positioning System sensor (“GPS sensor”) 740. It is contemplated that other sensors, such as, but not limited to, temperature sensors or shock detection sensors, also can be incorporated in the computing device architecture 700.

The magnetometer 730 is configured to measure the strength and direction of a magnetic field. In some configurations the magnetometer 730 provides measurements to a compass application program stored within one of the memory components 704 in order to provide a user with accurate directions in a frame of reference including the cardinal directions, north, south, east, and west. Similar measurements can be provided to a navigation application program that includes a compass component. Other uses of measurements obtained by the magnetometer 730 are contemplated.

The ambient light sensor 732 is configured to measure ambient light. In some configurations, the ambient light sensor 732 provides measurements to an application program stored within one the memory components 704 in order to automatically adjust the brightness of a display (described below) to compensate for low-light and high-light environments. Other uses of measurements obtained by the ambient light sensor 732 are contemplated.

The proximity sensor 734 is configured to detect the presence of an object or thing in proximity to the computing device without direct contact. In some configurations, the proximity sensor 734 detects the presence of a user's body (e.g., the user's face) and provides this information to an application program stored within one of the memory components 704 that utilizes the proximity information to enable or disable some functionality of the computing device. For example, a telephone application program can automatically disable a touchscreen (described below) in response to receiving the proximity information so that the user's face does not inadvertently end a call or enable/disable other functionality within the telephone application program during the call. Other uses of proximity as detected by the proximity sensor 734 are contemplated.

The accelerometer 736 is configured to measure proper acceleration. In some configurations, output from the accelerometer 736 is used by an application program as an input mechanism to control some functionality of the application program. For example, the application program can be a video game in which a character, a portion thereof, or an object is moved or otherwise manipulated in response to input received via the accelerometer 736. In some configurations, output from the accelerometer 736 is provided to an application program for use in switching between landscape and portrait modes, calculating coordinate acceleration, or detecting a fall. Other uses of the accelerometer 736 are contemplated.

The gyroscope 738 is configured to measure and maintain orientation. In some configurations, output from the gyroscope 738 is used by an application program as an input mechanism to control some functionality of the application program. For example, the gyroscope 738 can be used for accurate detection of movement within a 3D environment of a video game application or some other application. In some configurations, an application program utilizes output from the gyroscope 738 and the accelerometer 736 to enhance control of some functionality of the application program. Other uses of the gyroscope 738 are contemplated.

The GPS sensor 740 is configured to receive signals from GPS satellites for use in calculating a location. The location calculated by the GPS sensor 740 can be used by any application program that requires or benefits from location information. For example, the location calculated by the GPS sensor 740 can be used with a navigation application program to provide directions from the location to a destination or directions from the destination to the location. Moreover, the GPS sensor 740 can be used to provide location information to an external location-based service, such as E911 service. The GPS sensor 740 can obtain location information generated via WI-FI, WIMAX, and/or cellular triangulation techniques utilizing one or more of the network connectivity components 706 to aid the GPS sensor 740 in obtaining a location fix. The GPS sensor 740 can also be used in Assisted GPS (“A-GPS”) systems.

The I/O components 710 include a display 742, a touchscreen 744, a data I/O interface component (“data I/O”) 746, an audio I/O interface component (“audio I/O”) 748, a video I/O interface component (“video I/O ”) 750, and a camera 752. In some configurations, the display 742 and the touchscreen 744 are combined. In some configurations two or more of the data I/O component 746, the audio I/O component 748, and the video I/O component 750 are combined. The I/O components 710 can include discrete processors configured to support the various interface described below, or can include processing functionality built-in to the processor 702.

The display 742 is an output device configured to present information in a visual form. In particular, the display 742 can present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 742 is a liquid crystal display (“LCD”) utilizing any active or passive matrix technology and any backlighting technology (if used). In some configurations, the display 742 is an organic light emitting diode (“OLED”) display. Other display types are contemplated.

The touchscreen 744 is an input device configured to detect the presence and location of a touch. The touchscreen 744 can be a resistive touchscreen, a capacitive touchscreen, a surface acoustic wave touchscreen, an infrared touchscreen, an optical imaging touchscreen, a dispersive signal touchscreen, an acoustic pulse detection touchscreen, or might utilize any other touchscreen technology. In some configurations, the touchscreen 744 is incorporated on top of the display 742 as a transparent layer to enable a user to use one or more touches to interact with objects or other information presented on the display 742. In other configurations, the touchscreen 744 is a touch pad incorporated on a surface of the computing device that does not include the display 742. For example, the computing device can have a touchscreen incorporated on top of the display 742 and a touch pad on a surface opposite the display 742.

In some configurations, the touchscreen 744 is a single-touch touchscreen. In other configurations, the touchscreen 744 is a multi-touch touchscreen. In some configurations, the touchscreen 744 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures can be implemented in software for use with the touchscreen 744. As such, a developer can create gestures that are specific to a particular application program.

In some configurations, the touchscreen 744 supports a tap gesture in which a user taps the touchscreen 744 once on an item presented on the display 742. The tap gesture can be used for various reasons including, but not limited to, opening or launching whatever the user taps. In some configurations, the touchscreen 744 supports a double tap gesture in which a user taps the touchscreen 744 twice on an item presented on the display 742. The double tap gesture can be used for various reasons including, but not limited to, zooming in or zooming out in stages. In some configurations, the touchscreen 744 supports a tap and hold gesture in which a user taps the touchscreen 744 and maintains contact for at least a pre-defined time. The tap and hold gesture can be used for various reasons including, but not limited to, opening a context-specific menu.

In some configurations, the touchscreen 744 supports a pan gesture in which a user places a finger on the touchscreen 744 and maintains contact with the touchscreen 744 while moving the finger on the touchscreen 744. The pan gesture can be used for various reasons including, but not limited to, moving through screens, images, or menus at a controlled rate and/or indicating a command to pan or move data. Multiple finger pan gestures are also contemplated. In some configurations, the touchscreen 744 supports a flick gesture in which a user swipes a finger in the direction the user wants the screen to move. The flick gesture can be used for various reasons including, but not limited to, scrolling horizontally or vertically through menus or pages. In some configurations, the touchscreen 744 supports a pinch and stretch gesture in which a user makes a pinching motion with two fingers (e.g., thumb and forefinger) on the touchscreen 744 or moves the two fingers apart. The pinch and stretch gesture can be used for various reasons including, but not limited to, zooming gradually in or out of a web service, map, or picture.

Although the above gestures have been described with reference to the use one or more fingers for performing the gestures, other appendages such as toes or objects such as styluses can be used to interact with the touchscreen 744. As such, the above gestures should be understood as being illustrative and should not be construed as being limiting in any way.

The data I/O interface component 746 is configured to facilitate input of data to the computing device and output of data from the computing device. In some configurations, the data I/O interface component 746 includes a connector configured to provide wired connectivity between the computing device and a computer system, for example, for synchronization operation purposes. The connector can be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 748 is configured to provide audio input and/or output capabilities to the computing device. In some configurations, the audio I/O interface component 748 includes a microphone configured to collect audio signals. In some configurations, the audio I/O interface component 748 includes a headphone jack configured to provide connectivity for headphones or other external speakers. In some configurations, the audio interface component 748 includes a speaker for the output of audio signals. In some configurations, the audio I/O interface component 748 includes an optical audio cable out.

The video I/O interface component 750 is configured to provide video input and/or output capabilities to the computing device. In some configurations, the video I/O interface component 750 includes a video connector configured to receive video as input from another device (e.g., a video media player such as a DVD orBLU-RAY player) or send video as output to another device (e.g., a monitor, a television, or some other external display). In some configurations, the video I/O interface component 750 includes a High-Definition Multimedia Interface (“HDMI”), mini-HDMI, micro-HDMI, DisplayPort, or proprietary connector to input/output video content. In some configurations, the video I/O interface component 750 or portions thereof is combined with the audio I/O interface component 748 or portions thereof.

The camera 752 can be configured to capture still images and/or video. The camera 752 can utilize a charge coupled device (“CCD”) or a complementary metal oxide semiconductor (“CMOS”) image sensor to capture images. In some configurations, the camera 752 includes a flash to aid in taking pictures in low-light environments. Settings for the camera 752 can be implemented as hardware or software buttons.

Although not illustrated, one or more hardware buttons can also be included in the computing device architecture 700. The hardware buttons can be used for controlling some operational aspect of the computing device. The hardware buttons can be dedicated buttons or multi-use buttons. The hardware buttons can be mechanical or sensor-based.

The illustrated power components 712 include one or more batteries 754, which can be connected to a battery gauge 756. The batteries 754 can be rechargeable or disposable. Rechargeable battery types include, but are not limited to, lithium polymer, lithium ion, nickel cadmium, and nickel metal hydride. Each of the batteries 754 can be made of one or more cells.

The battery gauge 756 can be configured to measure battery parameters such as current, voltage, and temperature. In some configurations, the battery gauge 756 is configured to measure the effect of a battery's discharge rate, temperature, age and other factors to predict remaining life within a certain percentage of error. In some configurations, the battery gauge 756 provides measurements to an application program that is configured to utilize the measurements to present useful power management data to a user. Power management data can include one or more of a percentage of battery used, a percentage of battery remaining, a battery condition, a remaining time, a remaining capacity (e.g., in watt hours), a current draw, and a voltage.

The power components 712 can also include a power connector, which can be combined with one or more of the aforementioned I/O components 710. The power components 712 can interface with an external power system or charging equipment via a power I/O component.

In some examples, the handheld device as described in various examples herein, can be used in conjunction with a virtual reality application. For example, the handheld device may be used to control an object in a virtual reality space. In these and other examples, the position of the handheld device may be used as an input to the operation or movement of the object in the virtual reality application.

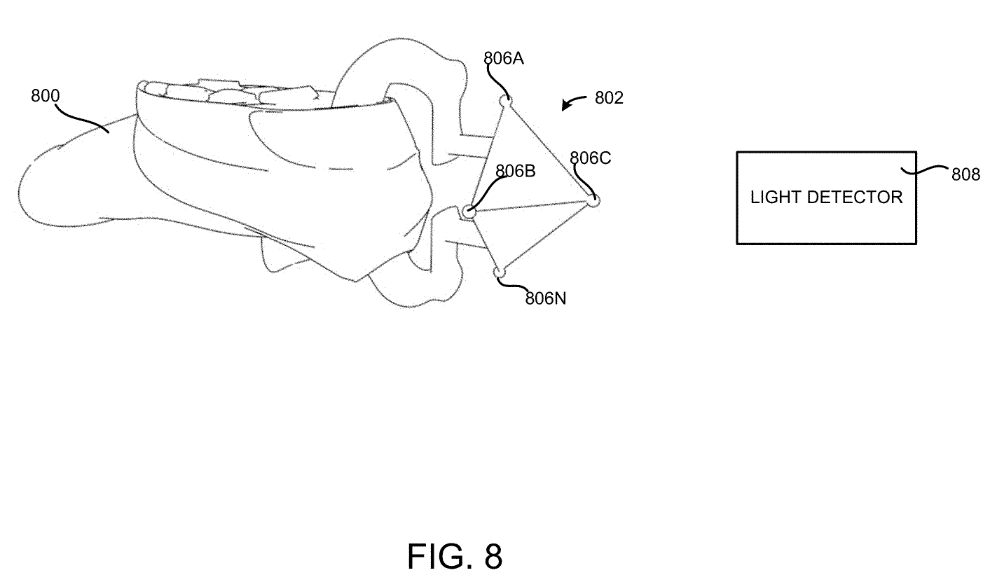

FIG. 8 is an illustration of a handheld device 802 with a positional attachment 804. The positional attachment 804 may be removably affixed to the handheld device 800 or may be permanently installed. For example, the positional attachment 804 may be wrapped around and affixed to the handheld device 802. The positional attachment 804 includes light sources 806 A-806N, such as IR, at locations on the positional attachment 804. The light sources 806 A-806N can be installed at vertices or particular locations on the positional attachment 804. In some examples, the positional attachment 804 is in the shape of a convex heptahedron, though it should be appreciated that other shapes may be used.

In some examples, the light sources 806 A-806N may be detected at a light detector 808. The light detector 808 may be a stand-alone device or may be part of a system, such as the receiving device 104 of FIG. 1. The presently disclosed subject matter is not limited to any particular configuration. The light sources 806 A-806N are configured to provide positional information (such as X, Y, and Z information in a Cartesian coordinate system). In some examples, an additional light detector may be used to enhance the accuracy of the positional information.

Based on the foregoing, it should be appreciated that technologies for operating a spatial detection system have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes can be made to the subject matter described herein without following the example configurations and applications illustrated and described, and without departing from the true spirit and scope of the present invention, aspects of which are set forth in the following claims.

What is claimed is:

1. A method of determining a position of a handheld device, the method comprising:
receiving, at a camera comprising a plurality of pixels, light waves from an infrared (IR) light emitting diode (LED);
measuring a plurality of intensities of the light waves at the plurality of pixels; and
determining the position of the handheld device in a two-dimensional matrix based on the measured plurality of intensities of the light waves at the plurality of pixels.

2. The method of claim 1, wherein the pixels of the camera establish the two-dimensional matrix.

3. The method of claim 1, wherein determining the position of the handheld device based on the measured plurality of intensities of the light waves at the plurality of pixels comprises weighting and averaging the plurality of intensities across the plurality of pixels.

4. The method of claim 1, further comprising determining non-rotational movement or positional information of the handheld device using a gyroscope.

5. The method of claim 4, further comprising determining lateral motion information using an accelerometer.

6. The method of claim 5, further comprising transmitting the position, the non-rotational movement or positional information, or the lateral motion information of the handheld device to a receiving device for use in a game or medical application.

7. The method of claim 1, further comprising smoothing a detected movement from the position to a second position by measuring the movement from the position to the second position along a plurality of curves.

8. The method of claim 1, wherein horizontal and vertical values in the two-dimensional matrix are calculated at the same time using radians.

9.A handheld device, comprising:
a camera comprising a plurality of pixels in a two-dimensional matrix configured to receive light waves from an infrared (IR) light emitting diode (LED);
a position calculator configured to:
measure a plurality of intensities of the light waves at the plurality of pixels; and
determine the position of the handheld device in the two-dimensional matrix based on the measured plurality of intensities of the light waves at the plurality of pixels.

10. The handheld device of claim 9, wherein the pixels of the camera establish the two-dimensional matrix.

11. The handheld device of claim 9, wherein determining the position of the handheld device based on the measured plurality of intensities of the light waves at the plurality of pixels comprises weighting and averaging the plurality of intensities across the plurality of pixels.

12. The handheld device of claim 9, further comprising a gyroscope to determine non-rotational movement or positional information of the handheld device.

13. The handheld device of claim 12, further comprising an accelerometer to determine lateral motion information.

14. The handheld device of claim 13, further comprising a positional attachment, the positional attachment comprising a plurality of light sources to provide positional information.

15. The handheld device of claim 9, wherein the position calculator is further configured to smooth a detected movement from the position to a second position by measuring the movement from the position to the second position along a plurality of curves.

16. The handheld device of claim 9, wherein horizontal and vertical values in the two-dimensional matrix are calculated at the same time using radians.

17. A non-transitory computer-readable storage medium having instructions stored thereupon which, when executed by the processor, cause the processor to:
receive, at a camera comprising a plurality of pixels, light waves from an infrared (IR) light emitting diode (LED);
measure a plurality of intensities of the light waves at the plurality of pixels; and
determine the position of the handheld device in a two-dimensional matrix based on the measured plurality of intensities of the light waves at the plurality of pixels.

18. The non-transitory computer-readable storage medium of claim 17, wherein the computer-executable instructions to determine the position of the handheld device based on the measured plurality of intensities of the light waves at the plurality of pixels comprises instructions to weight and average the plurality of intensities across the plurality of pixels.

19. The non-transitory computer-readable storage medium of claim 17, further comprising computer-executable instructions to smooth a detected movement from the position to a second position by measuring the movement from the position to the second position along a plurality of curves.

20. The non-transitory computer-readable storage medium of claim 17, wherein horizontal and vertical values in the two-dimensional matrix are calculated at the same time using radians.
